(19) United States
(12) Patent Application Publication
(10) Pub. No.: US 2025/0370463 A1
(43) Pub. Date: Dec. 4, 2025

(54) Perception-Based Worksite Control System

(71) Applicant: Caterpillar Inc., Peoria, IL (US)

(72) Inventors: Andrew T. Whitten, Dunlap, IL (US); Adam Jacobson, Chermside West (AU); Matthew A. Holmes, Metamora, IL (US); David J. Bumpus, Peoria, IL (US)

(73) Assignee: Caterpillar Inc., Peoria, IL (US)

(21) Appl. No.: 18/678,421

(22) Filed: May 30, 2024

(51) Int. Cl. G05D 1/617; G05D 1/244; G05D 111/60

(52) U.S. Cl. CPC G05D 1/617; G05D 1/244; G05D 2111/60

(57) ABSTRACT

A control system manages a plurality of mobile machines each equipped with a visual perception system to capture perception data. The control system via an onboard controller applies an object detection operation to the perception data to detect a detected marker position corresponding to a visual marker. The onboard controller assesses an assessed marker heath status with respect to the detected marker position and transmits that to a central worksite server. The central worksite server aggregates the assessed marker health statuses from a plurality of mobile machines to determine an aggregate marker health status for the visual marker.

### TECHNICAL FIELD

This patent disclosure relates generally to the management and coordination of mobile machines about a worksite and, more particularly, to a worksite control system and methodology utilizing perception-based localization and positioning techniques.

### BACKGROUND

The development of large-scale worksites, such as in mining or landscaping, involves the communication and coordination of information about the worksite between the personnel and mobile machines that are developing the worksite. A variety of different mobile machines need to move to different locations about the worksite to conduct different assigned tasks. For example, to haul material, haul machines such as haul trucks used in mining are off road, large scale mobile machines specifically designed for transporting significant quantities of material, e.g., several tons, about the worksite. Other examples of mobile machines include dozers, loaders, excavators, graders, etc.

To coordinate travel of the mobile machines about the worksite, a central administrative or planning unit is often established. The central unit is responsible for monitoring and managing worksite activities and assigning and allocating resources to complete worksite tasks efficiently. This includes monitoring development of the worksite, including gathering and updating information as the worksite changes. To the extent available, the central unit may rely on computer systems and telecommunication networks to conduct and complete its responsibilities. The central unit may receive information and data about the worksite development, including information from the mobile machines, and may maintain that information in an electronic worksite map that can dynamically change in response to updates.

Various systems and methodologies have been developed to capture, coordinate and communicate information maintained at the central unit and to comprehensibly present it about the physical worksite. On system involves the use of flags and markers to designate particular locations and/or worksite activities. Many mobile machines, however, are being configured for autonomous operation in which human interaction is reduced. To enable an autonomous mobile machines to navigate and travel about the worksite, for example, by recognizing the flags and markers as well as other objects and landmarks, the machines may be configured with a perception based locating system that utilizes machine vision and object detection technologies. U.S. Pat. No. 11,378,964 describes a system and method in which autonomous mobile machines are equipped with perception sensors for coordinating movement about worksite such as a mine.

The present disclosure is directed to improvements in similar environments using perception-based locating technologies to coordinate navigation and operation of mobile machines at worksite that in some instances may by autonomously controlled.

### SUMMARY

The disclosure describes, in one aspect, a worksite control system for managing a plurality of mobile machines operating at a worksite. The mobile machines each include a visual perception system able to capture perception data about the worksite and a position/navigation system able to determine a machine location of the mobile machine. The mobile machines also include an onboard electronic controller to apply an object detection operation to the perception data to detect a visual marker. The onboard controller also assess an assessed marker health status associated with the visual marker. The worksite control system also includes a central worksite server that are receives a plurality of the assessed marker heath statuses from a plurality of mobile machines. To aggregate and combine the information associated with the plurality of assessed visual marker statuses, the central worksite server conducts an error aggregation and assessment operation on the plurality of assessed marker heath statuses to generate an aggregated marker heath status associated with the visual marker. The central worksite server may also select a marker health status correction action.

In another aspect, the disclosure describes a method of managing a plurality of mobile machines operating at a worksite. The method captures perception data of a worksite with a visual perception associated with the mobile machines. A visual marker is detected in the perception data and assigned a detected marker position. The method assesses an assessed marker health status with respect to the detected marker position that notes any corresponding marker position errors. The assessed marker health status is transmitted to form the mobile machine to a central workplace server. At the central worksite server, the plurality of assessed marker health statuses from a plurality of mobile machines are aggregated and processed by an error aggregation and assessment operation to determine an aggregate marker health status. The method may further determine and output a marker health status correction.

In yet another aspect, the disclosure describes a worksite control system for managing a plurality of mobile machines that includes an onboard assessment unit and an offboard aggregation unit. The onboard assessment unit is configured to receive perception data captured about the worksite; to apply an object detection operation to the perception data to detect a visual marker; to assign a detected marker position associated with the visual marker; to assess an assessed marker health status associated with the visual marker, and transmit the assessed marker heath status. The offboard aggregation unit is configured to receive a plurality of assessed marker health statuses from a plurality of mobile machines; to conduct an error aggregation and assessment operation on the plurality of assessed marker heath statuses; to output an aggregated marker heath status associated with the visual marker; and to select a marker health status correction action.

### BRIEF DESCRIPTION OF THE DRAWINGS

FIG. 1 is a schematic illustration of a worksite such as a mine or quarry having a plurality of mobile machines cooperatively operating with a perception-based locating and navigation control system implemented in accordance with the disclosure.

FIG. 2 is schematic block diagram of the onboard and centralized offboard components and features of a computerized worksite control system implemented in accordance with the disclosure.

FIG. 3 is a flow diagram of the possible features and operations that may be conducted by an onboard electronic controller of the computerized worksite control system.

FIG. 4 is a flow diagram of the possible features and operations that may be conducted by the centralized offboard worksite server of the computerized worksite control system.

### DETAILED DESCRIPTION

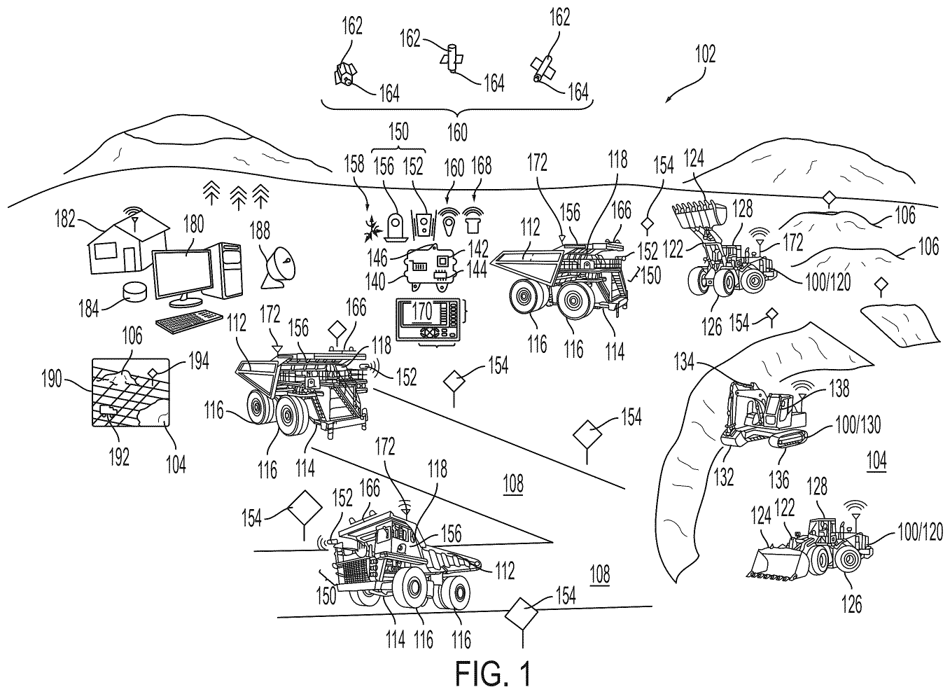

Now referring to the drawings, wherein whenever possible like reference numbers will refer to like elements, there is illustrated in FIG. 1 a plurality of mobile machines 100 operating at worksite 102 such as a mine or a quarry for extraction, processing, and distribution of mined material such as coal, ore, minerals, construction aggregate, and the like. However, aspects of the disclosure may be applicable to other types of worksites 102 where coordinated activities are simultaneously occurring, including large-scale construction sites, agricultural sites, and the like.

Various different operations, tasks, and processes may be conducted at different locations and at different stages in the worksite 100. By way of example, to obtain the raw materials, the worksite 102 may be associated with one or more mines 104, which are the physical locations where the raw materials are excavated from the ground. The mine 104 may be an open-pit or open cast surface mine in which the overburden (vegetation, dirt, and the like) is stripped away and removed to access the raw materials underneath. The raw materials may be separated from the ground by drilling, hammering, or blasting operations and removed from the mine 104. In other examples, the mine 104 may be a subsurface or underground mine in which tunnels are dug into the earth to access the raw materials.

The separated materials may be temporally deposited in one or more material piles 106 located at different places about the worksite 102. A fundamental activity at the worksite 100 is to transport materials between the mines 104 and material piles 106, and from material piles 106 offsite and away from the worksite 102, generally referred to as hauling. To enable the mobile machines 100 to travel around the worksite 100 between the mines 104 and material piles 106, one or more unpaved travel routes 108 or travel paths can be established about the worksite 100. Because of the ongoing activities and unfinished nature of the worksite 106, the travel routes 108 are typically unpaved and comprise paths of compacted earthen materials to support movement of the mobile machines, although some portions may be paved and comprise structures like bridges, designated lanes, and the like. The travel routes 108 can be designed to efficiently and expeditiously direct the mobile machines 100 around the worksite 102 and avoid obstacles, hazards, and other critical areas.

Among the plurality of mobile machines 100, haul trucks or haul machines 110 are particularly suited for the transportation of material about the worksite 102. Off-road hauling machines 110 can include a hauling body 112, which may be a dump body, into which material may be loaded. The hauling body 112 can be hinged to a machine frame 114 and can be articulated to dump material at a designed location. The machine frame 114 can be supported on a plurality of wheels 116 to propel and move about the worksite 102. To power propulsion by rotation of the wheels 116, the hauling machine 110 can include a power source or power plant such as an internal combustion engine for the combustion of hydrocarbon-based fuels to convert the latent chemical energy therein to motive power; although other examples of suitable power sources include electric motors associated with rechargeable batteries or fuel cells.

To accommodate an onboard operator, the hauling machine 110 can include an onboard operator station 118, which may be an enclosed space situated on the machine frame 114 at a location to provide visibility about the worksite 102. Located in the operator station 118 can be various machine controls and operator interfaces, such as steering, speed and direction controls, through which the operator controls operation of the haul machine 110. In accordance with the disclosure and described below, the haul machines 110 may also be configured for autonomous or semi-autonomous operation, or may be remotely controlled by an offboard operator using a remote control transmitter.

To sustain the rugged operating conditions about the worksite 102, the hauling machine 100 may be designed for off-road operation and may be characterized by its ability to travel over unpaved or unfinished, often rugged, surfaces is are often configured for heavy duty or hazardous operating conditions. Further, the off-road hauling machine 110 can be configured to accommodate the significant material quantities involved in a mining operation with the volumetric capacity of the haul body 112 sized to accommodate several tons. Another example of hauling machines 100 that may operate at the worksite 102 can be on-road trucks, characterized by their ability for long-distance travel on paved surfaces and roadways.

To load material to the hauling machines 110, one or more loading machines 120 in the embodiment of a bucket loader can also operate about the worksite 102. The loading machine 120 can include a lifting implement 122 with an attached bucket 124 shaped as an opened trough to receive material. The lifting implement 122 can be raised and lowered to move material from the material piles 106 and deliver it the hauling machine 110. The loading machine 120 can be supported on a plurality of wheels 126 for movement between the material piles 106 and haul machines 110 and may be powered by an internal combustion engine or an electrical power source. To accommodate an onboard operator, the loading machine 120 can also include an operator station 128 in which machine controls and operator interfaces are located, although in some examples, operational activities of the loading machine 120 can be automated or remotely controlled.

To dislodge and separate material from the worksite 102, another example of a mobile machine 100 can be an excavator 130 that includes a bucket 132 disposed at the end of another mechanical lift implement 134 that can articulate in various directions to maneuver the bucket. The lift implement 134 can be a mechanical linkage including a boom, a dipper, and a stick pivotally connected to each other. In addition to digging and excavating the material, excavators 120 can be used for loading haul machines 110, demolishing structures or obstacles, and the like. Typically, the excavator 120 can be operatively supported on a plurality of ground-engaging traction devices like continuous tracks 136 through a rotatable platform or undercarriage that rotates to swing the bucket 132 and lift implement 134 about the vertical axis of the excavator. To accommodate an onboard operator, the excavator 130 can also include an operator station 138 that is rotatably supported on the continuous tracks 136, although again in some examples, operational activities of the loading machine 120 can be automated or remotely controlled.

In addition to the foregoing examples, other types of mobile machines 100 may operate at the worksite 102 for material handling and transportation. For example, dozers may include a forward mounted blade elevated to push material over the surface of the worksite 102 and tankers can be used for carrying water or fuel about the worksite. As used herein, the term “machine” refers to any type of machine that performs some operation associated with an industry such as mining, construction, farming, transportation, or any other industry known in the art.

Moreover, the mobile machines 100 described herein can be operated manually, autonomously, or semi-autonomously. During manual operation, an onboard operator controls and directs essentially all the functions and activities of the machine using the controls in the operator station described above. Manual operation may also occur remotely wherein the operator is located off board the mobile machine 100 and operation is controlled through a remote control transmitter and wireless communication techniques.

In autonomous operation, the mobile machine 100 can operate responsively to information about the operating and environmental conditions of the worksite 102 provided from various sensors by selecting and executing various determined responses to the received information. Autonomous mobile machines 100 include a computerized control system comprising hardware and software configured to make independent decisions based on programmed rules and logic. In semi-autonomous operation, an operator either onboard or working remotely may perform some tasks and functions while others are conduced automatically in response to information received from sensors.

In any of the above examples, to assist navigation, travel and operation of the mobile machine 100 about the worksite, the mobile machines 100 can be operatively associated with an onboard navigation and control system that may be functionally implemented through an onboard electronic controller 140. The onboard electronic controller 140 can be a programmable computing device and can include one or more microprocessors 142 for executing software instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip.

To store application software and data, the onboard electronic controller 140 can include a non-transitory computer readable and/or writeable data memory 144 or similar data storage that can be embodied, for example, read only memory (“ROM”), random access memory (“RAM”), EPROM memory, flash memory, or etc. The data memory 144 is capable of storing software in the form of computer executable programs including instructions, definitions, and electronic data for the operation of the mobile machine. The programs can include equations, algorithms, charts, maps, lookup tables, databases, and the like.

To interface and network with the other components and operational systems on the mobile machine 100, the onboard electronic controller 140 can include an input/output interface 146 to electronically send and receive non-transitory data and information. The input/output interface 144 can be physically embodied as data ports, serial ports, parallel ports, USB ports, jacks, and the like to communicate via conductive wires, cables, optical fibers, or other communicative bus systems. The input/output interface 146 can communicatively transmit data and information embodied as electronic signals or pulses through physical transmission media such as conductive wires or as optical pulses through fiber optics. Communication can also occur wireless through the transmission of radio frequency signals. Communication can occur via any suitable communication protocol for data communication including sending and receiving digital or analog signals synchronously, asynchronously, or elsewise.

To obtain and provide data and information about the worksite conditions and activities to the electronic controller 140, the onboard navigation and control system can be operatively associated with a visual perception system 150 located on the mobile machine 100. The visual perception system 150 can capture visual perception data about structures and objects about the worksite 102, including other machines, that the onboard electronic controller 140 can process and appropriately respond to. The perception data can include information such distances, ranges, dimensional sizes and shapes, features, orientations, etc. The perception data may be presented as a three dimensional physical space and can be referenced with respect to Euclidean or Cartesian coordinate systems. By sequentially or repetitively capturing perception data, the electronic controller 140 can also discern motion and movement information including speed and direction of moving objects or physical changes of the worksite over time.

In an embodiment, the visual perception system 150 can include a LIDAR (light detection and ranging) device 152. A LIDAR device 152 includes a light source or emitter that projects a laser or light beam in a specific direction that impinges upon and is reflected by material objects. The reflected light can be captured by a detector associated with the LIDAR device 152 and the elapsed time between projection and return of the light, and other characteristics of the reflected light such as intensity, can be processed and analyzed for ascertaining visual and definitional information regarding the reflecting object or terrain such as distance, size, shape, etc.

To serve as a target for the LIDAR device 152, a plurality of visual markers 154 can be placed about the worksite 102. The visual markers 154 are artificial structures of a defined shape and size that can reflect the laser or light beam projected from the LIDAR device. For example, the visual markers 154 can be planar diamond shaped plates that provide a two dimensional (X-Y) area that provides a defined shape that is readily recognizable by the LIDAR device 152. The visual marker 154 can be made from sheet metal and can be sized and colored for reflectivity and to enhance visibility, for example, approximately 2 meters by 2 meters in size and brightly painted. The visual markers 154 may have other shapes and configurations to render them prominent and conspicuous about the worksite 102. The visual markers 154 can include visual characters such as text, caricatures, and geometric patterns to convey comprehensible information to observers about the worksite 102 and associated with the location of the visual marker. In some embodiments, the visual markers 154 may also be associated with natural landmarks and features that can be visually detected and are recognizable by the LIDAR device 152.

The visual markers 154 can positioned to spatially designate or demarcate features and landmarks about the worksite 102. For example, because the intended off-road travel routes 108 may be difficult to visually discern from the surrounding terrain, visual markers 154 can be placed along the sides of travel routes 108 and function as navigation guides or wayfinders for the traveling mobile machines 100. The visual markers 154 can also be used to designate locations such as the mine 104 or the material piles 106, and may include visual characteristics or symbols to convey comprehensible information about or associated with the worksite location. To elevate the visual marker 154 above the terrain surface of the worksite 102 and enhance visibility, the planar panel can be mounted to a post that can be planted into the ground. The visual marker 154 can also be mounted to other natural or artificial objects such as trees, fences, equipment, etc., at the worksite or, as indicated, the visual markers may be associated with recognizable natural features and landmarks.

Other types of objects can function as physical markers. For example, tires or artificial or natural structures may be detectable by the LIDAR device, smart camera or other detection and the perception-based localization and navigation system 150 may be configured to recognize those objects as physical markers 154.

The perception data captured by the LIDAR device 152 can be recorded as a three-dimensional point cloud comprised of a plurality of individual reflected points produced by rapid projections from the light source. The plurality of individual points of the point cloud are plotted in an array having defined coordinates for spatial location. The combined characteristics of the individual points, such as intensity, provide a visual image detailing the shape and dimensions of the scanned objects and background. The perception data creating the point cloud can be stored and transmitted as a computer readable image data file that the onboard electronic controller 140 can process. The LIDAR device 152 can be communicatively connected to and networked with the input/output interface 146 to send the image data files to the onboard electronic controller 140.

The LIDAR device 152 can be mounted on the machine frame 114 of, for example, the haul machine 110 to establish visibility over the worksite 102. The LIDAR device 150 can be rotated with respect to the machine frame 114 to capture wider visual angles or sweeps during scanning. To increase the captured visual area, multiple LIDAR devices 150 can be mounted to the machine frame 114, for example, at the front and rear ends of the haul machines 110.

In another embodiment, the visual perception device 150 can be a smart camera 154 that is mounted to the mobile machine 100. A smart camera 156 can be a machine vision system that can capture visual perception data embodied as visual digital images from its field of view and can include data analysis and processing capabilities to extract contextual and relational information regarding the perception data. The smart camera 156 can be programmed to specifically search for, recognize and/or identify the visual marker 154. The smart camera 156 can include automated autofocus, pan, and zoom functions to improve operation. The smart camera 156 can capture individual stationary images or continuous video which may be stored as a computer readable and transmissible image data file.

In another embodiment, the perception system can make use of a different technology, for example, acoustic or radio frequency waves like radar. Similar to LIDAR, radar uses the transmission and reflection of radio waves by an object to determine its location, geometry, and travel with respect to a receiver, which can be interpreted to visualize objects such as mobile machines and the associated activities within the surrounding worksite 102.

To establish the frame of reference and locational context of the visual perception data capture by the visual perception system 150, an orientation determining device such as an inertial measurement unit (IMU) 158 can be operatively included with the LIDAR device 152 or smart camera 156. The IMU 158 can measure the applied forces caused by motion and/or acceleration of the device and can therefore determine its orientation and/or position. In an embodiment, the IMU 158 can be sensitive to magnetic fields to obtain orientation with respect the magnetic field of the Earth. The information obtained by the IMU 158 provides referential or contextual association for the visual perception data captured by the visual perception system 150 such as the direction and orientation from where the data was obtained.

To provide additional referential information, the navigation and control system can include a position/navigation system 160 that is configured to determine a current position of the mobile machine 100 at the worksite 102. The position/navigation system 160 can be realized as a global navigation satellite system (GNSS) or global positioning satellite (GPS) system. In the GNSS or GPS system, a plurality of manmade satellites 162 orbit about the earth at fixed or precise trajectories. Each satellite 162 includes a positioning transmitter 164 that transmits positioning signals encoding time and positioning information towards earth. By calculating, such as by triangulation, between the positioning signals received from different satellites, one can determine their instantaneous location on earth.

To receive the satellite transmissions, positioning receivers 166 are located on each of the plurality of mobile machines 100. The positioning receivers 166 are antennas sensitive to the positioning signals and convert those signals to electrical signals the onboard electronic controller 140 can process. The positioning receivers 166 are mounted for adequate reception on the mobile machines 100 such as near the top of the machine frame. In an embodiment, the positioning receivers 166 can include two spaced apart receivers that enables the position/navigation system 160 to determine angular orientation of the mobile machine 100 at the worksite 102 in addition to geographic location.

The position/navigation system 160 may also be configured as a laser based system in which a plurality of laser transmitters are located about the worksite. The laser transmitters transmit laser light that can be sensed by optical sensors on the mobile machines 100. If the precise location of the laser transmitters is known, it can be appreciated that the actual position of the mobile machine within the physical worksite can be determined. Such determination can be conducted based upon, as examples, the Doppler effect of the laser light or time periods between laser incidents on the transmitter/receivers.

To provide additional information and data for use by the onboard navigation control system, the mobile machine 100 can include one or more machine sensors 168 that are in data communication with the onboard electronic controller 140. The machine sensors 168 can be any device for detecting or measuring a physical condition or change therein and outputting data representative of that occurrence. The machine sensors 168 can work on any suitable operating principle for the assigned task, and may make mechanical, electrical, visual, and/or chemical measurements.

For example, the machine sensors 168 can be configured to measure travel speed or velocity of the mobile machine 100 propelling about the worksite 102. Travel speed can be measured directed from rotation or translation of the wheels or continuous tracks, or may be measured indirectly such as by reflected acoustic or audio waves transmitted between the mobile machines 100 and the immediate surroundings at the worksite 102. The machines sensors 168 can also be engine sensors associated with the power source or engine of the mobile machine 100 and can measure engine output in terms of torque or engine speed, combustion information, and other engine information. The machine sensors 168 can also be environmental sensors that measure environmental conditions in which the mobile machines are operating, such as environmental temperature, weather conditions, visibility, etc.

To interface with the operator, the onboard electronic controller 140 can be associated with a human machine interface (HMI) that may be embodied as a visual display screen 170. The visual display screen 170 can visually present information to a human operator regarding operation of the mobile machine 100. The visual display screen 170 can be a liquid crystal display (“LCD”) capable of presenting numerical values, text descriptors, graphics, graphs, charts and the like regarding operation. The visual display screen 1 may have touch screen capabilities to receive input from a human operator, although in other embodiments, other interface devices may be included such as dials, knobs, switches, keypads, keyboards, mice, printers, etc.

To communicate with other mobile machines 100 at the worksite 102, a transceiver 172 can be mounted to each of the mobile machines at an accessible location. The transceiver 172 can be configured for wireless communications and can send and receive wireless data transmissions using any suitable communication protocol such as WiFi. The transceiver 172 can be operatively connected to the onboard electronic controller 140.

To coordinate operation among the plurality of mobile machines 100 at the worksite 102, the onboard electronic controller 140 of each navigation and control system on the mobile machines can, through the transceiver 172, communicate and cooperate with a central worksite server 180. The central worksite server 180 is located offboard with respect to the mobile machines 100 and can be remotely located at a stationary facility or building structure 182 at worksite 102 or elsewhere. The central worksite server 180 can be maintained by the operator of the worksite 102 or can be contracted to an independent application service provider (ASP).

The central worksite server 180 includes computer hardware and software that provides functionality and resources supporting on the ongoing operations and activities at the worksite. The central worksite server 180 can host software applications and programming and can provide supplemental processing capabilities that can be accessed and used by other computing systems at the worksite 102. The central worksite server 180 can serve as a central network node for communications and can function as a central repository for collection of data. The central worksite server 180 can control access to worksite data and computational resources utilized by other systems with which it is networked. The central worksite server 180 can administer and manage assignments and tasks related to worksite activities and operations to the plurality of mobile machines 100 and other equipment. The central worksite server 180 can also be configured and programmed to identify operational errors and faults and to resolve such problems and discrepancies. The central worksite server 180 can function as the control center for the worksite 102.

The central worksite server 180 can include one or more microprocessors for the execution of software applications and computer programs and the processing of digital data. To interface with worksite personnel, the central worksite server 180 can include input-output peripherals such as display monitors and keyboards for the entry and presentation of data. Although the central worksite server 180 is illustrated as a single standalone unit at a single location, the hardware and functionality may be distributed among different devices at multiple locations.

The central worksite server 180 can include a data storage 184 that contains and maintains computer readable data about the operations and activities of the worksite 102 including the plurality of mobile machines 100. The data storage 184 can log and store data about the plurality of mobile machines 100 such as the identities, geographic locations, functional capabilities, and assigned tasks. The data storage 184 can maintain a data table or log about the mobile machines and an electronic worksite map which may be a computer generated virtual representation about the worksite including geographical or topographical features such as terrain conditions, elevations, conditions, structures, objects, landmarks, etc.

To communicate with the plurality of mobile machines 100 via the transceivers 172 mounted thereon, the central worksite server 180 can be operatively associated with a telematics system 188. The telematics system 188 can broadcast and receive wireless communications through radio waves about the worksite over sufficient distances to cover the worksite. The telematics system 188 can use any suitable wireless protocol or standard such as Wi-Fi.

The central worksite server 180 can be responsible for generating and maintaining an electronic worksite map 190 that can be a virtual, computer-readable representation of the worksite 102 that can be rendered on a visual display system. Embodied as data file, the electronic worksite map 190 can be stored and communicated electronically between computer systems associated and networked to and associated with the central worksite server 180. The electronic worksite map 190 may be in three dimensions and can depict the geography and topology of the worksite 102. The electronic worksite map 190 can be referenced to a coordinate system and can be produced at a reduced scale to represent distances and elevations of the worksite topology. The electronic worksite map 190 and can designate features, landmarks, and objects including, for example, the mine 104, material piles 106 and travel paths 108.

As the worksite 102 develops, the geography and topology can change. The electronic worksite map 190 can be dynamic and represent changes and modifications of these elements with respect to time. To make changes and updates, information may be communicated to the central worksite server 180 via the telematics system 188 from, for example, the mobile machines 100 in operating at the worksite 102. The electronic nature of the electronic worksite map 190 facilities dynamic and automatic updates.

In addition to the geographic elements, the electronic worksite map 190 can also designate and track the location of the plurality of mobile machines 100 using electronic machine designations 192. The electronic machine designations 192 can include information about the corresponding mobile machines 100 including identification, operating capabilities, assigned tasks, etc. Because the central worksite server 180 is in electronic communication via the telematics system 188 with the plurality of mobile machines 100, the central worksite server 180 can receive updated and current location data as the mobile machines 100 moving about the worksite 102 as determined by the position/navigation system 160.

The electronic worksite map 190 can also designate the location and/or status of the visual markers 154 placed around the worksite 102. As part of the layout of the worksite 102, the visual markers 154 are placed as predesignated or assigned locations that can be recorded and represented in the electronic worksite map 190 by assigned marker positions 194. The assigned marker positions 194 can include information about the corresponding visual marker 154, such as its status, meaning, or duration at its present location.

As the worksite 102 changes and develops, the locations and/or meanings of the visual markers 154 may also need to be changed and updated. Visual markers 154 may be removed, replaced or obstructed as the worksite 102 develops. To track and account for changes to the visual markers 154, the onboard navigation and control system implemented by the onboard electronic controller 140 and the central worksite server 180 can cooperatively embody a worksite control system to make corresponding updates to the assigned marker positions 184 in the electronic worksite map 190.

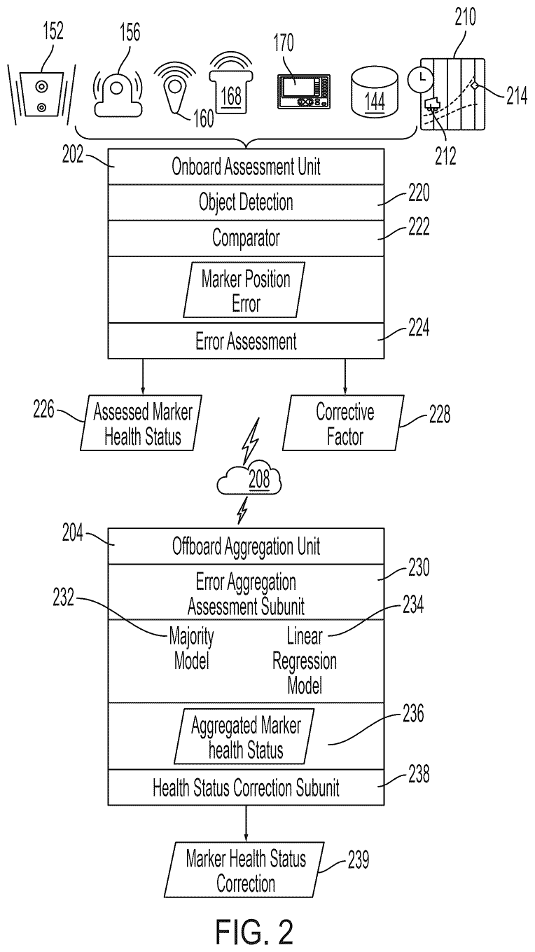

Referring to FIG. 2, there is schematically illustrated a diagram of the components and functionality of the worksite control system 200 for maintaining information about visual markers and the corresponding assigned marker positions 194 in the electronic worksite map 190. The worksite control system 200 can be a distributed system and includes an onboard component or aspect that is associated with the mobile machines 100 and an offboard aspect that is associated with the central worksite server 180. The onboard aspect associated with the mobile machines 100, referred to as the onboard assessment unit 202, can detect and assess the conditions of the visual markers 154 in the physical worksite 102 and the offboard aspect corresponding with the central worksite server 180, referred to as the offboard aggregation unit 204, can collect and aggregate marker data from the plurality of mobile machines 100. The onboard assessment unit 202 and the offboard aggregation unit 204 comprise and communicate over a worksite communication network 208 over which data and information can be wirelessly communicated, for example, using the transceivers 172 on the mobile machines 100 and the telematics system 178 associated with central worksite server 180.

The onboard assessment unit 202 can be operatively associated with the visual perception system 150, which may be embodied as the LIDAR device 152 or smart camera 156 located on the mobile machine 100. To obtain and assign a location to the perception data captured by the visual perception system 150, the onboard assessment unit 202 can also be associated with the position/navigation system 160 of the mobile machine 100. The onboard assessment unit 202 can also be operatively associated with the machine sensors 168 and the onboard HMI, which may be embodied as a visual display 170 described above.

The visual display 170 may render and visually present the electronic worksite map 190 to an operator onboard the mobile machine 100. The electronic worksite map 190 can be sent to the onboard assessment unit 202 from the offboard aggregation unit 204 associated with the central worksite server 180 through the worksite communication network 208. The electronic worksite map 190 can be stored in a data storage associated with the onboard assessment unit 202 that, for example, can be the memory 144 associated with the onboard electronic controller 140. The onboard assessment unit 202 therefore can access the plurality of assigned marker positions 194 recorded in the electronic worksite map 190, which can be presented on the visual display 170.

In an embodiment, the onboard assessment unit 202 can be configured to develop a local electronic map 210 that can be unique to the mobile machine 100 associated with the onboard assessment unit 202. For example, as the mobile machine 100 travels around the worksite 100, the onboard assessment unit 202 can use the visual perception system 150 and the position/navigation system 160 to record the surrounding worksite conditions and the present location of the mobile machine 100. The captured perception data and machine locations can be stored as historic data in the memory 144 of the onboard electronic controller 140. The onboard electronic controller 140 can be programmed to conduct a simultaneous localization and mapping (SLAM) process to build the local electronic map 210 of the immediate surroundings the mobile machine 100 navigates through the worksite 100.

Examples of elements and features included in the local electronic map 210 by the onboard assessment unit 202 may include the current and past machine locations 212 of the mobile machine 100 obtained by the position/navigation system 160. If the visual perception system 150 detects a visual marker 154, the location and orientation relative to the mobile machine 100 may be recorded as a detected marker position 214. Furthermore, using the past or historical locations of the mobile machine 100 obtained by the position/navigation system 160, the onboard assessment unit 202 can determine the geography or topology of the surrounding environment including the distances between features and the elevations of the features. The local electronic map 210 can indicate the locations of the perceived features in reference to a two dimensional (X-Y) or three-dimensional (X-Y-Z) coordinate system.

More particularly, when the visual perception system 150 observes elements and objects in the environment, the onboard assessment unit 202 records that observation as perception data in the memory 144. The location of the observed object or element can be determined from the ranging capabilities of the visual perception unit 150, which determines the distance to the observed object from the mobile machine 100, and the relative location of the mobile machine 100 obtained by the position/navigation system 160. The visual perception system 150 can also capture and record information, as a type of perception data, that is related to the orientation or pose of the detected worksite element relative to the mobile machine 100. Orientation may be determined by continued observation of the object recorded by the visual perception system 150 during relative movement between the worksite element and the mobile machine 100. For example, relative motion enables the visual perception system 150 to record perception data from different angles and/or distances with respect to the worksite element allowing a more accurate assessment of the shape and size.

To determine and assess the condition or health status of a visual marker 154, the onboard assessment unit 202 can be configured with functionalities embodied as logical circuitry corresponding, for example, to the processor 142 of the onboard electronic controller 140 and software for processing the perception data captured by the visual perception system 150. In a specific embodiment, to detect and recognize a visual marker 154 in the perception data, the onboard assessment unit 202 can include an object detection subunit 220. The object detection subunit 220 may include machine vision technology that can apply a computer model or algorithm to extract and identify specific, individual features in the captured perception data. For example, the features of the captured perception data can be internally compared for extraction and can be referenced with known data about similar features for classification and identification. The object detection subunit 220 can use any suitable object detection model or algorithm known in the art. When visual markers 154 are detected by the object detection subunit 220, they may be recorded in the local election map 210 as the detected marker positions 214.

To compare the condition of the visual marker 154 as detected by the visual perception unit 150 with a reference, the onboard assessment unit 202 can include a comparator subunit 222. For example, the comparator subunit 222 retrieves information about the visual marker from the worksite electronic map 190 sent by the central worksite server 180. The information may include the assigned marker position 194 for the visual marker 154 that can be determined from the worksite electronic map 190. The comparison subunit 222 compares the data regarding the detected marker position 214 and the assignment marker position 194 to detect errors with respect to the visual marker 154. For example, the marker position error may be inconsistences between the specified or assumed position of the visual marker 154, represented by the assigned marker position 194 and the detected marker position 214 obtained by the visual perception system 150. More specifically, the marker position error may related to inconsistencies about the dimensional coordinates associated with the visual marker 154, such as it geographic location, its size and shape, its position, orientation, etc.

In an embodiment, the comparator subunit 222 can compare information about an assigned marker position 194 with results from the object detection subunit 220 indicating the absence of a visual marker 154 among the perception data obtained by the visual perception system 150. In other words, the onboard assessment unit 202, by operation of the object detection subunit 220 and the comparator subunit 222, can detect the absence of a visual marker 154 in the physical worksite 102, contrary to indication of an assigned marker position 194 in the worksite electronic map 190.

In an embodiment, the comparator subunit 222 can recognize that the perceptibility or saliency of the visual marker 154 is obscured or obscured. For example, the comparator subunit 222 can assess or measure the quality of the perception data associated with the detected marker position 214, which can indicate degraded or deficient perceptibility or resolution. In a specific example, the perception data may be a point cloud, and the comparator subunit 222 can compare or assess the quality, granularity, or detail of the point cloud with a baseline or anticipated value or level associated with the assigned marker position 194 from the worksite electronic map 190. Discrepancies between the quality of the point cloud perception data and the anticipated expected quality can indicate that the visual marker is obstructed or obscured (e.g. by overgrowth or other physical obstructions, accumulation such as mud, dirt, snow or ice, etc.).

If the comparator subunit 222 detects marker position errors between the assigned marker position 194 and the detected marker position 214, the onboard assessment unit 202 can conduct error diagnostics by invoking an error assessment subunit 224. For example, the error assessment subunit 224 can conduct a plurality of decisions or comparisons, possibly modeled as a decision tree or decision table, to further determine the cause of the marker position error, including further analysis of the perception data captured by the visual perception units, resolving particular discrepancies of features that should be common between the assigned marker position 194 and the detected marker position 214, analyzing other machine and/or environmental data obtained from the machine sensors 168, etc.

As a result of diagnosing the marker position error, the error assessment subunit 224 can assign and output an assessed marker health status 226 with respect to the visual marker 154. The assessed marker health status 226 represents the current condition of the visual marker and the assessment by the onboard assessment unit 202 of the cause for the marker position error. Examples of the assessed marker health status 226 can include a missing visual marker, an incorrect location for a visual marker, an incorrect orientation of a visual marker, a damaged visual marker, an obscured visual marker, duplicate visual markers, etc. The assessed marker health status 226 may also indicate that the visual marker, while present at the location corresponding to the assigned marker position 214, is obstructed or obscured, for example, by objects such as other mobile machines or overgrowth. The visual marker may be obstructed by the physical accumulation of dirt, mud, snow, ice, etc. In an embodiment, the assessed marker health statuses 226 can be available in a directory with definitions corresponding the marker position errors.

To note the marker position error, the onboard assessment unit 202 can transmit the assessed marker heath status 226 as a data signal to the offboard aggregation unit 204 via the worksite communication network 208. The marker health status 226 can be packaged and transmitted with other relevant data such as the identification and location of the mobile machine 100 which observed the visual marker 154 and machine and environmental data about the relevant operating conditions obtained by the machine sensor 168. Other relevant data may include distance and/or orientation between the mobile machine 100 and the observed visual marker 154. The additional data transmitted with the assessed marker health status 226 can be referred to as corrective data 228 and used for corrective purposes described below.

The offboard aggregation unit 204 can receive the assessed marker health statuses 226 from a plurality of mobile machines 100 regarding the same visual marker 154. To determine the actual health status of the visual marker 154, the offboard aggregation unit 204 can combine and aggregate the plurality of assessed marker health statuses 226 from different onboard assessment units 202 and received by the offboard aggregation unit 204, and it can conduct further analysis on the aggregated data. For example, the offboard aggregation unit 204 can include an error aggregation and assessment subunit 230 that is configured to apply a computer model, in form the logic, instructions, and definitions, to assess the aggregated data. The model used by the error aggregation and assessment subunit 230 can conduct a plurality of decisions, possibly modeled as a decision tree or decision table, to determine the actual health status of the visual marker.

For example, the error aggregation and assessment unit 230 can apply a majority model 232 in which the health or condition of the visual marker, as indicated by majority of the assessed health statues 226 receive, is selected as the actual marker heath status. If the majority of the assessed marker heath statuses 226 received indicate that a visual marker 154 is missing, the error aggregation and assessment unit 230 pursuant to the majority model 232 selects that as the actual cause for the marker position error. The majority model 232 can dispense with atypical or mistaken indications in the individual assessed marker health statuses 226 that may arise, for example, is a visual marker 154 is temporarily blocked or obstructed by other mobile machines.

As another example, the error aggregation and assessment subunit 230 can apply a weighted analysis model 234 that applies weights and biases to the plurality of assessed marker heath statuses 226 received. The corrective data 228 transmitted with the individual assessed health statuses 226 can be used by the error aggregation and assessment subunit 230 to weight and/or bias the individual assessed health statuses 226 received by the offboard aggregation unit 204. For example, if a first mobile machine 100 was located at a greater distance to the perceived the visual marker 154 than a second mobile machine 100, the assessed marker heath status 226 from the first mobile machine may be attributed less weight or importance. Likewise, if a first mobile machine 100 perceived the visual marker 154 under conditions of reduced visibility, the assessed marker heath status 226 from the first mobile machine may be attributed less weight or importance.

The result of the processing conducted by the error aggregation and assessment subunit 230 using the majority and/or weighted analysis models 232, 234 can be designated as an aggregated marker heath status 236. The aggregated marker heath status 236 corresponds to the determination by the offboard aggregation unit 204 of the actual cause of the marker position error as detected and assessed by a plurality of onboard assessment units 202.

In an embodiment, the offboard aggregation unit 204 can also include a health status correction subunit 238. The health status correction subunit 238 can include functionality or be programmed to resolve or remedy the marker position error. The health status correction subunit 238 can make or output a marker heath status correction 239 based on the aggregated marker heath status 236. Examples of marker heath status corrections 239 may include updating the worksite electronic map 190 to reflect the aggregate marker heath status 236 or to dispatch worksite personnel to the replace or reposition the visual marker 154.

### INDUSTRIAL APPLICABILITY

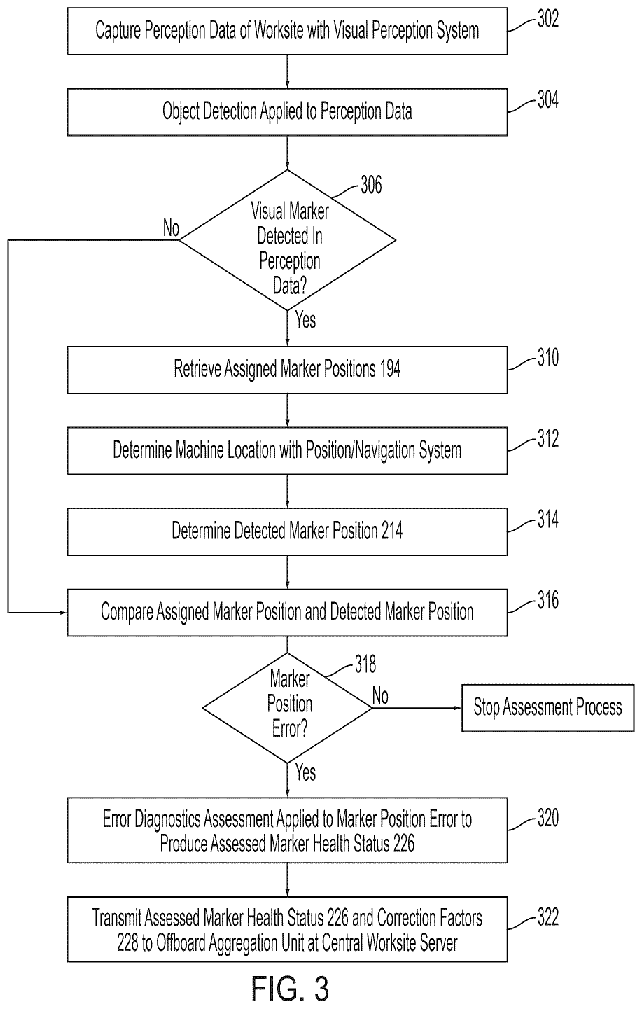

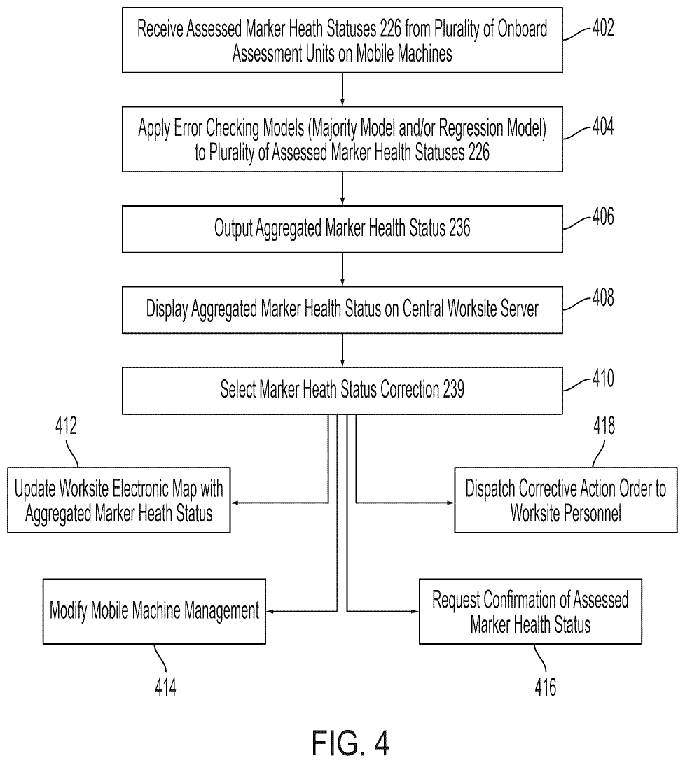

Referring to FIG. 3-4, with continued reference to the preceding figures, there are illustrated flow diagrams of possible events and actions that can be undertaken by the worksite control system 200 to manage use and reliance on the plurality of visual markers 154 that can be positioned about the worksite 102. The described methods can be implemented as non-transitory, computer-executable software programs written in any suitable programming language and run on any suitable computer architecture utilizing one or more processors and peripheral devices. For example, the central worksite server 180 and the onboard electronic controllers 140 on the plurality of mobile machines 100 may cooperatively interact as part of the worksite communication network 208 to conduct the disclosed methods. The assignments and responsibilities for the individual steps and actions of the flow diagrams may be distributed between the computing systems. In accordance with the disclosure, the plurality of mobile machine 100 can be operated autonomously, semi-autonomously or manually at the worksite 102.

FIG. 3 can correspond to the operations and processes conducted by the onboard assessment unit 202 of the worksite control system 200 that may reside on or be embodied in the onboard electronic controller 140 of the mobile machines 100. In a data capture step 302, visually represented information about the conditions and environment of the physical worksite 102 can be captured by the visual perception system 150 on the mobile machines 100 traveling about the worksite. Examples of the perception data obtained by the visual perception system 150 include a point cloud generated and output by the LIDAR device 152 and captured images taken by a smart camera 156. The perception data as electrical or digital data signals is transmitted and stored in the memory 144 of the onboard electronic controller 140 for further processing.

The onboard electric controller 140, which may correspond or be associated with to the onboard assessment unit 202, can conduct an object detection process or operation 304 on the perception data to detect the presence of a visual marker 154. The onboard assessment unit 202 can be programmed or configured to use any suitable object detection model or algorithm to isolate and classify features and elements in the perception data as part of the object detection operation 304. The results of the objection detection operation 304 are assessed in a marker detection decision 306 that confirms whether a visual marker 154 is in the perception data. The absence of a visual marker 154 in the perception data can also be useful information to the worksite control system 200.

The comparator subunit 222 can conduct a series of computer executable operations to determine the existence of a marker position error. For example, in a retrieval step 310, the onboard electronic controller 140 can retrieve the assigned marker position 194 previously associated with the visual markers 154 in the physical worksite 102. The assigned marker positions 194 can be retrieved from the worksite electronic map 190 if stored in the memory 144 of the onboard electronic controller 140, although the assigned marker positions 194 may be available from other sources or determined by other methods.

The comparator subunit 222 can also determine and assign a detected marker position 214 to the visual marker 154 as perceived in the perception data. In the embodiments wherein the onboard electronic controller 140 develops a local electronic map 190 as the mobile machine 100 travels the worksite 102, the detected marker position 214 can be obtained from the local electronic map. For example, to assign a location and position for the detected marker position 194, the onboard assessment unit 202 can in a machine location determination 312 obtain the geographic location of the mobile machine 100 at the time the perception data was obtained using the position/navigation system 160. The onboard assessment unit 202 can also determine the range and the spatial pose or orientation of the visual marker 154 with respect to the mobile machine 100 using, for example, the image processing capabilities of the LIDAR device 152 or the smart camera 156. Based on the machine location from the position/navigation system 160 and the perception data from the perception system 150, the onboard assessment unit 202 through the onboard electronic controller 140 can make a marker position determination 314 assigning a geographic location and a spatial orientation for the visual marker 154 in the physical worksite 102 as perceived by perception system 150.

In a comparison step 316, the comparator subunit 222 compares the assigned marker position 194 previously obtained with the detected marker position 214 obtained from the marker position determination 314. The comparison step 316 may discover discrepancies or inconsistencies in, for example, the presence or absence of a visual marker 154, the geographic location of the visual marker 154, or the spatial pose and orientation of a visual marker, the size and shape or dimensional aspects of the visual marker, etc. Based on the comparison step 316, the comparator subunit 222 makes a marker error decision 318 to decide the existence of a marker position error corresponding to one or more of the noted discrepancies or inconsistencies.

In another embodiment, the marker error decision 318 may receive, as electronic data, the result of marker detection decision 306 that correspond to the absence of a visual marker 154 in the perception data. The marker error decision 318 may apply the assigned marker position 194 retrieved from, for example, the worksite electronic map 190 and compares that with the captured perception data indicating the absence of a visual marker 154. In such an instance, the marker error decision 318 decides a visual marker is not present contrary to indication in the worksite electronic map 190.

As a further aspect, the onboard assessment unit 202 can conduct an assessment operation 320 attempting to classify the marker position error discovered by the marker error decision 318. The assessment operation 320 can involve a plurality of discrete analytical decisions, possibly arranged as a decision tree or decision table. The assessment operation results in the output of an assess marker heath status 226, that represents the current physical condition of the visual marker 154 as observed by the perception system 150.

In a data transmission step 322, the onboard assessment unit 220 can wirelessly transmit from the machine transceiver 172 and through the worksite communication network 208 data signals encoding the assessed marker health status 226. As stated, in an embodiment, transmission of the assessed marker health status 326 can be combined with corrective factors 228 that are also obtained by the onboard assessment unit 202 relating to the operating condition and the physical environment of the mobile machine 100.

FIG. 4 can correspond to the operations and processes conducted by the offboard aggregation unit 204 of the worksite control system 200 that may reside on or be embodied in the central worksite server 180. In a data reception step 402, the offboard aggregation unit 204 can receive, via the telematics system 188, the transmitted assessed marker health statuses 226 from a plurality of mobile machines 100 traveling at the worksite 102.

To aggregate and combine the plurality of assessed marker health statuses 226 that may concern the same visual marker 154, the error aggregation and assessment subunit 230 can conduct an error aggregation and assessment operation 404. In the error aggregation and assessment operation 404, the offboard aggregation unit 204 using the functionality of the central worksite server 180 applies one or more error checking computer models, for example, the majority model 232 and/or the weighted analysis model 234, to determine an aggregated marker heath status 236. The aggregated marker heath status 236 represents an estimate of the actual physical condition of the visual marker 154 in the physical worksite 102 based on the aggregated combination of the assessed marker health statuses 236 received from the plurality of mobile machines 100.

The error aggregation and assessment subunit 230, in a status output step 406, can output computer operable data or files about the aggregated marker heath status 236 for further use. For example, in a status display step 408, the aggregated marker health status 236 and other relevant data for a particular visual marker 154 can be visually displayed to worksite personnel on a display monitor operatively associated with the central worksite server 180.

To resolve the marker position error or other problems associated with or underlying the aggregated marker health status 236, the health status correction subunit 238 error of the offboard aggregation unit 204 can conduct a selection step 410 to select a marker heath status correction 239. The selection step 410 can select one or more possible marker heath status corrections 239 and can arrive at its selection using preprogrammed logical decisions and rules or definitional relations. Examples of possible marker heath status corrections 239 can include a map update 412 in which the central worksite server 180 can update the worksite electronic map 190 to reflect the aggregated marker health status 236 as newly determined. In an embodiment, a plurality of possible marker heath status correction 239 can be maintained in a library with linking definitions corresponding to the aggregated marker health status 236. The offboard aggregation unit 204 can wirelessly transmit the updated worksite electronic map 190 to the onboard electronic controllers 140 associated the plurality of mobile machines 100 using the telematics system 188 and the worksite communication network 208.

The central worksite server 180 can also responsively use the aggregated marker health status 236 to manage operation and activities at the worksite 102. For example, because the central worksite server 180 may be responsible for administering the scheduling and assignment of tasks among the plurality of mobile machines 100, the health status correction subunit 238 can, in a modification step 414, modify schedules, tasks, travel directions, etc. for the mobile machines and other activities at the worksite 102. By way of example, information presented by the aggregated marker health status 236 can be exceptionally useful for collision avoidance.

Another example of a marker heath status correction 239 that may be output by the health status correction subunit 238 may be a confirmation request 416 requesting confirmation of the health status of the visual marker 154. The confirmation request 416 can request a mobile machine 100, or direct a mobile machine under autonomous operation, to travel to the visual marker 154 to gather additional or new perception data with the visual perception system 150 for further assessment and analysis. If the aggregated marker health status 236 indicates the visual marker 154 is missing, misplaced, or obstructed, the health status correction subunit 238 can select and dispatch a corrective action work order 418 to worksite personnel to the replace or reposition the visual marker 154.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A worksite control system for managing a plurality of mobile machines operating at a worksite comprising:
a plurality of mobile machines each including:
a visual perception system able to capture perception data about the worksite;
a position/navigation system able to determine a machine location of the mobile machine; and
an onboard electronic controller configured to apply an object detection operation to the perception data to detect a visual marker; assess an assessed marker health status associated with the visual marker, and transmit the assessed marker heath status; and
a central worksite server including:
a transceiver configured to receive a plurality of the assessed marker heath statuses associated with the visual marker from a plurality of mobile machines;
a data storage storing an worksite electronic map having that assigned marker position; and
a processor configured to conduct an error aggregation and assessment operation on the plurality of assessed marker heath statuses; output an aggregated marker heath status associated with the visual marker; and select a marker health status correction action.

2. The worksite control system of claim 1, wherein the onboard electronic controller further configured to assign a detected marker position associated with the visual marker.

3. The worksite control system of claim 2, wherein the onboard electronic controller is further programmed to retrieve an assigned marker position and to compare the detected marker position with the assigned marker position.

4. The worksite control system of claim 3, wherein the error aggregation and assessment operation includes one or more a majority model and a weighted analysis model.

5. The worksite control system of claim 4, wherein the majority model outputs the aggregated marker heath status from a majority among the plurality of assessed marker health statuses.

6. The worksite control system of claim 4, wherein the onboard electronic controller is configured to transmits corrective factors with the assessed marker health status.

7. The worksite control system of claim 6, wherein central worksite server weighs the plurality of the assessed marker health statuses based on the corrective factors.

8. The worksite control system of claim 1, wherein the central worksite server selects the marker health status correction from one or more of updating a worksite electronic map; modifying an activity regarding the mobile machine; requesting confirmation regarding the visual marker, and dispatching a corrective action work order to worksite personnel.

9. The worksite control system of claim 1, wherein the onboard electronic controller assesses the assessed marker heath status to be indicative of one or more of a missing visual marker, an incorrect location for a visual marker, an incorrect orientation of a visual marker, and duplicate visual markers.

10. The worksite control system of claim 1, wherein the onboard electronic controller assesses the assessed marker heath status to be indicative of one or more of an obstructed visual marker and an obscured visual marker.

11. The worksite control system of claim 10, wherein the onboard electronic controller assesses the assessed marker health statue to be indicative of accumulation to the obscured visual marker due to mud, dirt, snow, and/or ice.

12. The worksite control system of claim 1, wherein the visual perception system is one or more of a LIDAR device, a smart camera, and radar.

13. A computer-implemented method of managing a plurality of mobile machines operating at a worksite comprising:
capturing perception data of a worksite with a visual perception system operatively associated with a mobile machine operating at the worksite;
detecting a visual marker from the perception data and assigning a detected marker position to the visual marker;
assessing an assessed marker health status corresponding to a marker position error;
transmitting the assessed marker health status as transmission data from the mobile machine to a central worksite server;
receiving at the central workplace a plurality of assessed marker health statuses from a plurality of mobile machines operating at the worksite;
applying an error aggregation and assessment operation to the plurality of assessed marker health statuses to determine an aggregate marker health status; and
determining and outputting a marker health status correction.

14. The method of claim 13, further comprising comparing the detected marker position with an assigned marker position to decide if a marker position error has occurred with respect to the visual marker.

15. The method of claim 14, wherein the marker position error corresponds to one or more of a missing visual marker, an incorrect location for a visual marker, an incorrect orientation of a visual marker, and duplicate visual markers.

16. The method of claim 14, wherein the marker positon error corresponds to one or more of an obscured visual marker and an obstructed visual marker.

17. The method of claim 16, wherein the marker position error corresponds to accumulation to the visual marker due to mud, dirt, snow, and/or ice.

18. The method of claim 13, wherein the assigned marker position is retrieved from a worksite electronic map.

19. The method of claim 14, wherein the detected marker position is designated in a local electronic map generated by one of the plurality of mobile machines.

20. The method of claim 11, wherein the marker health status correction corresponds to one or more of updating a worksite electronic map; modifying an activity regarding the mobile machine; requesting confirmation regarding the visual marker, and dispatching a corrective action work order to worksite personnel.

21. The method of claim 11, wherein the error aggregation and assessment operation applies one of a majority model and a weighted analysis model to determine the aggregate marker health status from the plurality of assessed marker health statuses.

22. The method of claim 17, further comprising transmitting corrective factors as transmission data from the mobile machine with the assessed marker health status.

23. The method of claim 11, wherein the plurality of mobile machines are configured for autonomous operation.

24. A worksite control system for managing a plurality of mobile machines comprising:
an onboard assessment unit configured to receive perception data captured about the worksite; apply an object detection operation to the perception data to detect a visual marker; assign a detected marker position associated with the visual marker; assess an assessed marker health status associated with the visual marker, and transmit the assessed marker heath status;
an offboard aggregation unit configured to receive a plurality of assessed marker health statuses from a plurality of mobile machines, conduct an error aggregation and assessment operation on the plurality of assessed marker heath statuses; output an aggregated marker heath status associated with the visual marker; and select a marker health status correction action.
